(19) United States
(12) Patent Application Publication
(10) Pub. No.: US 2026/0211743 A1
(43) Pub. Date: Jul. 23, 2026

(54) LOAD DISTRIBUTION DEVICE, LOAD DISTRIBUTION METHOD, AND INFORMATION PROCESSING APPARATUS

(71) Applicant: Fujitsu Limited, Kawasaki-shi (JP)

(72) Inventor: Tetsuya ODAJIMA, Kawasaki (JP)

(73) Assignee: Fujitsu Limited, Kawasaki-shi (JP)

(21) Appl. No.: 19/412,964

(22) Filed: Dec. 9, 2025

(30) Foreign Application Priority Data
Jan. 21, 2025 (JP) 2025-008543

(51) Int. Cl. G06F 9/50

(52) U.S. Cl. CPC G06F 9/505; G06F 9/5083; G06F 2209/5022

(57) ABSTRACT

A load distribution device includes a memory and a controller coupled to the memory. The controller is configured to execute a control process including: monitoring a processing load of each of a plurality of processing devices configured to execute processing of a plurality of sub-models included in a machine learning model, and executing, when a first processing device having a processing load equal to or more than a first threshold is detected, first control for allocating a first sub-model to a second processing device to which a second sub-model different from the first sub-model is allocated, based on allocation of the plurality of sub-models and the plurality of processing devices, the second processing device being different from the first processing device to which the first sub-model is allocated and having the processing load less than the first threshold.

### CROSS-REFERENCE TO RELATED APPLICATION

This application is based upon and claims the benefit of priority of the prior Japanese Patent application No. 2025-008543, filed on January 21, 2025, the entire contents of which are incorporated herein by reference.

### FIELD

The present embodiment relates to a load distribution device, a load distribution method, and an information processing apparatus.

### BACKGROUND

One of the architectures for realizing a large language model (LLM) used for artificial intelligence (AI) tasks such as natural language processing is mixture of experts (MoE). The MoE is one of the techniques for implementing performance improvement of LLM by combining a plurality of experts, each of which is trained specifically for a different specific task. The plurality of experts are an example of a plurality of neural networks (NNs) included in a machine learning model (model, NN) as an LLM. Hereinafter, the expert may be referred to as a “sub-model”.

According to the MoE, since it is possible to improve the performance of LLM by increasing the number of experts, the scalability is high. By increasing the number of experts, it is possible to suppress an increase in the size (scale) of the entire model as compared with a case where the performance of LLM is improved by, for example, making the NN multilayered, making the NN structure complicated, or the like. In addition, in the MoE, by using a gateway that selects an optimal expert for input data, it is possible to improve the efficiency of LLM training and inference using a plurality of (for example, a huge amount of) data. Therefore, according to the MoE, it is possible to perform LLM training and inference with high accuracy while efficiently using calculation resources.

For example, related arts are disclosed in U.S. Patent Application Publication No. 2020/0084510, U.S. Patent Application Publication No. 2024/0086682, Japanese National Publication of International Patent Application No. 2019-537133, and Japanese Laid-open Patent Publication No. 2023-105469.

### SUMMARY

According to an aspect of the embodiment, a load distribution device includes a memory and a controller coupled to the memory. The controller is configured to execute a control process including monitoring a processing load of each of a plurality of processing devices configured to execute processing of a plurality of sub-models included in a machine learning model, and executing, when a first processing device having a processing load equal to or more than a first threshold is detected, first control for allocating a first sub-model to a second processing device to which a second sub-model different from the first sub-model is allocated, based on allocation of the plurality of sub-models and the plurality of processing devices, the second processing device being different from the first processing device to which the first sub-model is allocated and having the processing load less than the first threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of processing of an NN having a MoE structure;

FIG. 2 is a block diagram illustrating a hardware configuration example of a server illustrated in FIG. 1;

FIG. 3 is a block diagram illustrating a first mounting example of a monitoring unit in a server according to one embodiment;

FIG. 4 is a block diagram illustrating a second mounting example of the monitoring unit in the server according to one embodiment;

FIG. 5 is a block diagram illustrating a third mounting example of the monitoring unit in the server according to one embodiment;

FIG. 6 is a block diagram illustrating a functional configuration example of the server according to one embodiment;

FIG. 7 is a diagram illustrating an example of load distribution processing of an accelerator according to one embodiment;

FIG. 8 is a diagram illustrating an example of the load distribution processing of the accelerator according to one embodiment;

FIG. 9 is a diagram illustrating an example of the load distribution processing of the accelerator according to one embodiment; and

FIG. 10 is a flowchart illustrating an operation example of the server according to one embodiment.

### DESCRIPTION OF EMBODIMENTS

A gateway selects any expert to process the input data according to a routing algorithm. For this reason, when a bias occurs in the input data from the viewpoint of the selection criteria of the expert, there is a possibility that a specific expert is intensively selected. In such a case, a situation may occur in which some experts are overused while other experts are not fully utilized.

For example, in a case where one accelerator (processing device) executes processing of one expert, there is a possibility that a processing load of the accelerator executing the processing of some of the plurality of experts is increased due to excessive use of those experts.

As described above, in a case where a processing load is unbalanced among a plurality of experts, a processing load of a specific accelerator increases and becomes a bottleneck, and processing efficiency of an entire LLM decreases, so that optimization of performance may be hindered.

Hereinafter, embodiments will be described with reference to the drawings. However, the embodiments described below are merely examples, and there is no intention to exclude the application of various modifications and techniques that are not explicitly described below. For example, it is possible to variously modify and implement the present embodiment without departing from the gist thereof. Note that, in the drawings used in the following description, elements denoted by the same reference numerals represent the same or similar elements unless otherwise specified.

### A. Description of NN According to One Embodiment

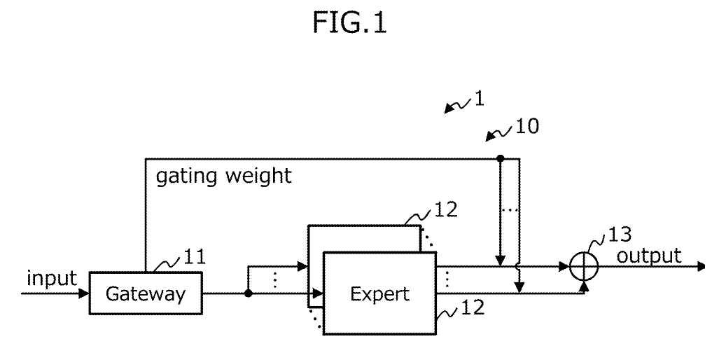

FIG. 1 is a diagram illustrating an example of processing of an NN 1 having a MoE structure 10. The NN 1 may be, for example, a large language model (LLM) used for AI tasks such as natural language processing. The NN 1 having the MoE structure 10 may provide a service as an LLM to a user, for example, a computer (hereinafter, it may be referred to as a “user terminal”) that accesses the NN 1 via a network such as the Internet not illustrated. In the following description including FIG. 1, attention is focused on the MoE structure 10 among the network structure that the NN 1 has.

For example, a token (represented as “input” in FIG. 1) obtained by dividing text data (character string data) input to the NN 1 into finer units may be input to the MoE structure 10, and a processing result (represented as “output” in FIG. 1) for the token may be output. The token is one or more character strings (lexemes or words) obtained by dividing the character string data at any one or more positions.

As illustrated in FIG. 1, the MoE structure 10 may include a gateway 11, a plurality of experts 12, and a synthesizer 13.

The gateway 11 is an example of a machine learning model (NN) connected to a preceding stage of the plurality of experts 12. The gateway 11 outputs a token input from its own preceding stage (for example, a layer or the like) in the NN 1 to one or more experts 12 selected from the plurality of experts 12 according to a routing algorithm. In other words, the gateway 11 is an example of an NN that distributes the input token to the plurality of experts 12 according to the token. The gateway 11 is an example of a router that performs routing to the expert 12. The gateway 11 may be connected to each of the plurality of experts 12 and the synthesizer 13.

The gateway 11 may output a token to each of the plurality of experts 12, and assign a weight (gating weight: see FIG. 1) corresponding to the token to the processing result from each of the plurality of experts 12 by a gating network. For example, in the processing result output from the MoE structure 10, the processing results of some experts 12 may be reflected more than the processing results of the other experts 12 by the weight corresponding to the token. As a result, selection of those of the experts 12 by the gateway 11 may be realized. In the following description, it is assumed that the processing in which the gateway 11 selects any one of the plurality of experts 12 according to a token includes processing related to weight assignment by the gating network.

The plurality of experts 12 are an example of a plurality of sub-models included in the NN 1 (in one embodiment, the NN of a portion corresponding to the MoE structure 10) as an LLM. Each of the plurality of experts 12 may be an NN that is trained specifically for a different specific task. Each of the plurality of experts 12 may be connected to the gateway 11 at the preceding stage and the synthesizer 13 at the subsequent stage, may execute processing on the token input from the gateway 11, and may output a processing result to the synthesizer 13. The processing of the MoE structure 10 among the NN 1 is realized by the plurality of experts 12.

As illustrated in FIG. 1, the MoE structure 10 illustrated in one embodiment illustrates an example in which a plurality of experts 12 are connected in parallel to a subsequent stage of one gateway 11, but is not limited thereto. For example, the MoE structure 10 may have a multi-stage configuration in which at least two experts 12 are connected in series (cascade). In a case where the MoE structure 10 has a multi-stage configuration, a processing result output from the expert 12 at the preceding stage may be input to the expert 12 at the subsequent stage.

The synthesizer 13 is an example of an arithmetic unit that synthesizes a processing result (for example, weighted data according to a token by the gateway 11) output from the expert 12. The synthesizer 13 may output the synthesized data as a processing result (output data) from the MoE structure 10, for example, store the data in a memory.

As illustrated in FIG. 1, the NN 1 according to one embodiment includes one MoE structure 10, but is not limited thereto, and may include a plurality of MoE structures 10. For example, in the NN 1, the plurality of MoE structures 10 may be any of a series structure (multistage structure) connected in series (cascade), a parallel structure connected in parallel, and a nested structure, or may be a combination of at least two of these structures. The nested structure is, for example, a structure in which one MoE structure 10 includes another MoE structure 10.

Furthermore, the NN 1 according to one embodiment may have a structure in which a plurality of gateways 11 are included in one MoE structure 10. In the case of this structure, for example, the preceding-stage gateway 11 may distribute the input data to one or more of a plurality of preceding-stage experts 12 and subsequent-stage gateways 11 connected to the subsequent stage of the preceding-stage gateway 11. When the input data is distributed to the subsequent-stage gateway 11, the subsequent-stage gateway may distribute the input data to a plurality of subsequent-stage experts 12 connected to the subsequent stage of the subsequent-stage gateway.

As described above, in the MoE structure 10 of the NN 1, the input data is appropriately distributed to the experts 12 each trained to be specialized for a different specific task. As a result, it is possible to improve the use efficiency of the calculation resources in the machine learning processing and the inference processing and it is possible to achieve the machine learning processing and the inference processing with high accuracy as compared with an NN not having the MoE structure 10.

However, as described above, in a case where input data is biased from the viewpoint of the selection criteria of the experts 12 by the gateway 11, there is a possibility that the specific expert 12 is intensively selected. In such a case, a situation may occur in which some experts 12 are excessively used while the other experts 12 are not sufficiently utilized. For example, in a case where one accelerator executes the processing of one expert 12, when the processing load is unbalanced among the plurality of experts 12, the processing load may be concentrated on a specific accelerator in the plurality of accelerators. As a result, the processing efficiency of the entire NN 1 decreases, and there is a possibility that optimization of performance is hindered.

Therefore, in the following description, a method of reducing (alleviating) concentration of a processing load on a specific accelerator in a plurality of accelerators that execute processing of a plurality of experts 12 will be described.

### B. Hardware Configuration Example

### B-1. Hardware Configuration Example of Server

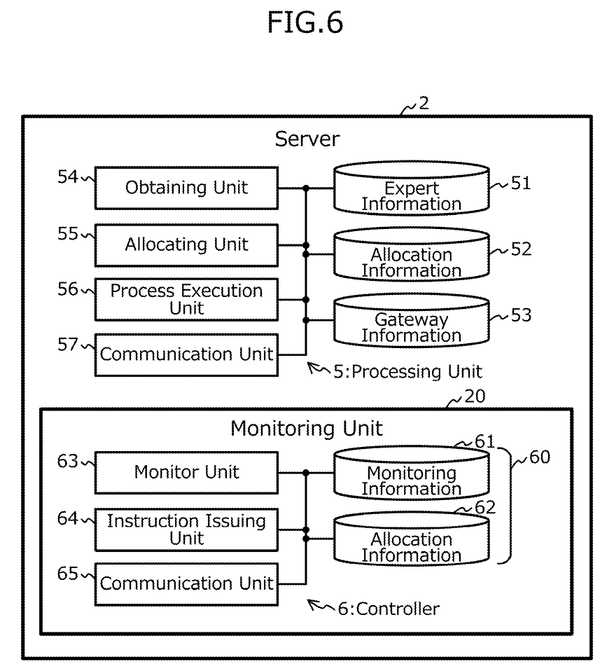

The function of the NN 1 illustrated in FIG. 1 may be realized by a server 2 (see FIG. 6). The function of the server 2 according to one embodiment may be realized by one computer or may be realized by two or more computers. Furthermore, at least some of the functions of the server 2 may be realized by using hardware (HW) resources and network (NW) resources provided by a cloud environment.

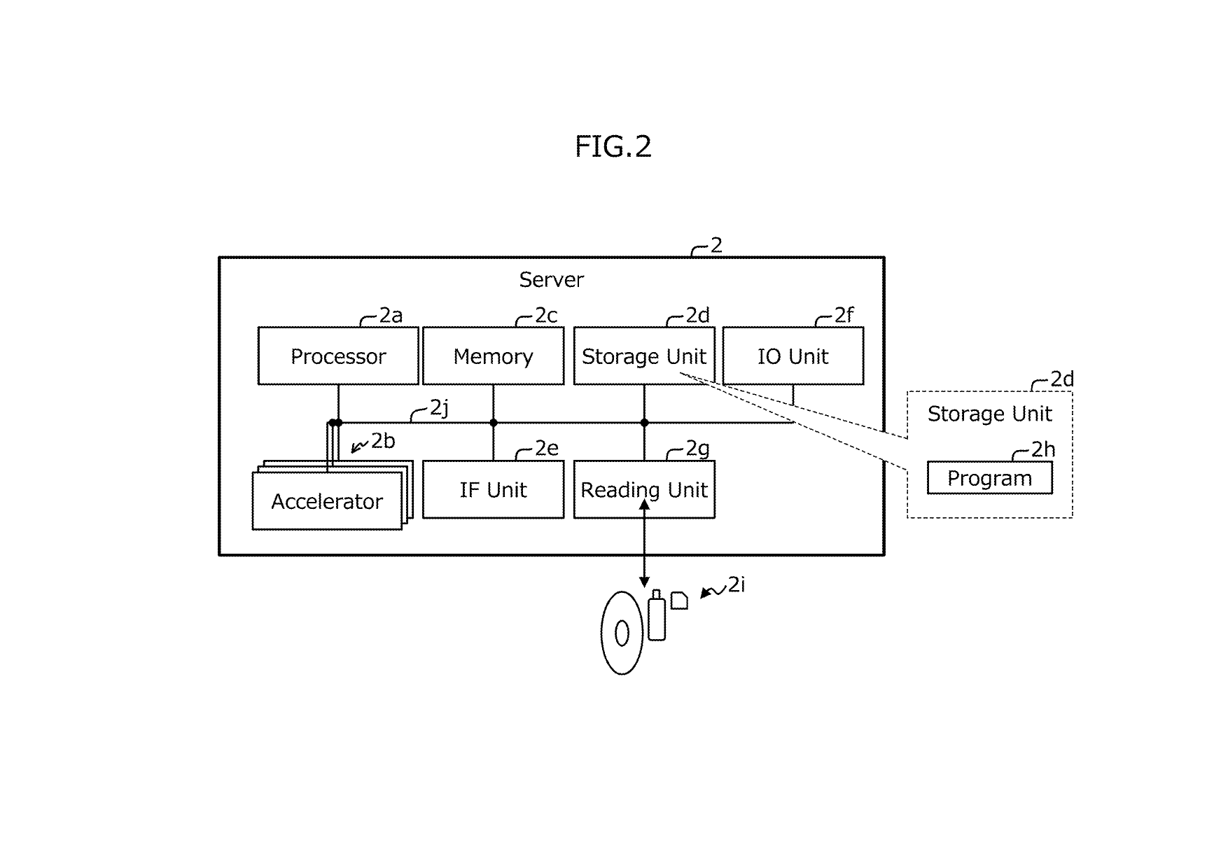

FIG. 2 is a block diagram illustrating a hardware configuration example of the server 2 illustrated in FIG. 1. In a case where a plurality of computers are used as the HW resource for realizing the function of the server 2, each computer may have the HW configuration illustrated in FIG. 2.

As illustrated in FIG. 2, the server 2 may illustratively include a processor 2a, a plurality of accelerators 2b, a memory 2c, a storage unit 2d, an interface (IF) unit 2e, an input/output (IO) unit 2f, and a reading unit 2g as the HW configuration.

The processor 2a is an example of an arithmetic processing device that performs various controls and calculations. The processor 2a may be communicably connected to each block in the server 2 via a bus 2j. The processor 2a may be a multiprocessor including a plurality of processors, may be a multi-core processor including a plurality of processor cores, or may have a configuration including a plurality of multi-core processors.

Examples of the processor 2a include an integrated circuit (IC) such as a CPU, an MPU, an APU, a DSP, an ASIC, or an FPGA. A combination of two or more of these integrated circuits may be used as the processor 2a. CPU is an abbreviation for Central Processing Unit, and MPU is an abbreviation for Micro Processing Unit. APU is an abbreviation for Accelerated Processing Unit. DSP is an abbreviation for Digital Signal Processor, ASIC is an abbreviation for Application Specific IC, and FPGA is an abbreviation for Field-Programmable Gate Array.

The accelerator (hereinafter, it may be referred to as “ACC”) 2b is an arithmetic processing device that executes AI processing such as machine learning processing and inference processing using the NN 1 including the experts 12, and may be referred to as an AI accelerator. The ACC 2b is an example of a processing device. Each of the plurality of ACCs 2b may execute processing as the expert 12 illustrated in FIG. 1, or may execute processing as the gateway 11 or the synthesizer 13 illustrated in FIG. 1 in cooperation with the processor 2a. The ACC 2b may have a configuration as a graphics processing device (graphics accelerator) that performs screen display control on an output device such as a monitor in the IO unit 2f.

Examples of the ACC 2b include various arithmetic processing devices, for example, an integrated circuit (IC) such as a GPU, an APU, a DSP, an ASIC, or an FPGA. For example, the ACC 2b may conform to a PCIe (Peripheral Component Interconnect Express) standard as a bus architecture, and may conform to various other communication protocols such as NVLink (registered trademark).

The memory 2c stores information such as various data and programs. Examples of the memory 2c include one or both of a volatile memory such as a dynamic random access memory (DRAM) and a nonvolatile memory such as a persistent memory (PM).

The storage unit 2d stores information such as various data and programs. Examples of the storage unit 2d include various storage devices such as a magnetic disk device such as a hard disk drive (HDD), a semiconductor drive device such as a solid state drive (SSD), and a nonvolatile memory. Examples of the nonvolatile memory include a flash memory, a storage class memory (SCM), and a read only memory (ROM).

The storage unit 2d may store a program 2h that implements all or some of various functions of the server 2. For example, by the processor 2a of the server 2, it is possible to realize a function as a processing unit 5 (see FIG. 6) to be described later by loading the program 2h stored in the storage unit 2d in the memory 2c and executing the program 2h.

The IF unit 2e is an example of a communication IF that performs control of connection and communication between the server 2 and another computer (for example, the user terminal or an administrator terminal used by an administrator of the server 2). For example, the IF unit 2e may include an adapter conforming to a communication standard such as PCIe, Ethernet (registered trademark), InfiniBand, or Millinet. The adapter may support one or both of wireless and wired communication systems. In addition, the adapter may conform to optical communication such as a fiber channel (FC).

The program 2h may be downloaded from a network (not illustrated) to the server 2 via the communication IF and stored in the storage unit 2d.

The IO unit 2f may include one or both of an input device and the output device. Examples of the input device include a keyboard, a mouse, and the like. Examples of the output device include the monitor, a projector, a printer, and the like. In addition, the IO unit 2f may include a touch panel or the like in which the input device and a display device are integrated. The output device may be connected to the accelerator 2b.

The reading unit 2g is an example of a reader that reads information of data and programs recorded on a recording medium 2i. The reading unit 2g may include a connection terminal or a device to which the recording medium 2i can be connected or inserted. Examples of the reading unit 2g include an adapter conforming to a universal serial bus (USB) or the like, a drive device that accesses a recording disk, a card reader that accesses a flash memory such as an SD card, and the like. The program 2h may be stored in the recording medium 2i, and the reading unit 2g may read the program 2h from the recording medium 2i and store the program 2h in the storage unit 2d.

Examples of the recording medium 2i include a non-transitory computer-readable recording medium such as a magnetic/optical disk or a flash memory. Examples of the magnetic/optical disk include a flexible disk, a compact disc (CD), a digital versatile disc (DVD), a Blu-ray disc, a holographic versatile disc (HVD), or the like. Examples of the flash memory include semiconductor memories such as a USB memory and an SD card.

The above-described HW configuration of the server 2 is an example. Therefore, an increase or decrease in HW in the server 2 (for example, addition or deletion of an arbitrary block), division, integration in an arbitrary combination, addition or deletion of a bus, or the like may be appropriately performed.

### B-2. Mounting Example of Monitoring Unit in Server

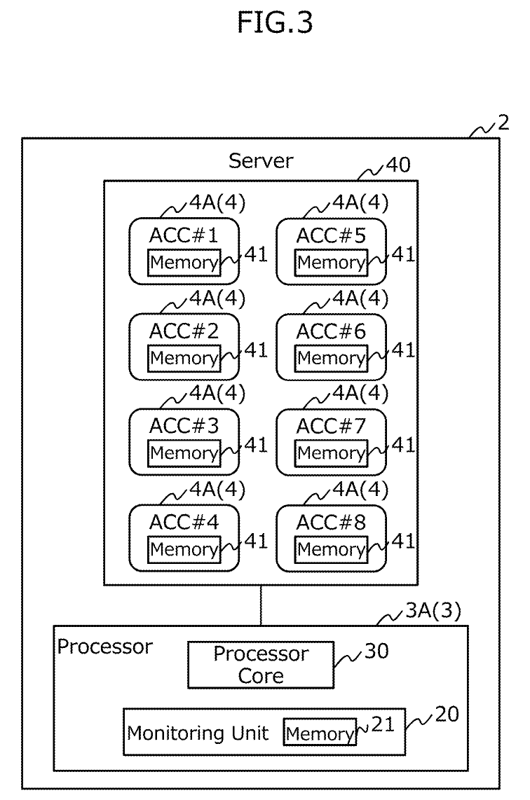

FIGS. 3 to 5 are block diagrams illustrating first to third mounting examples of a monitoring unit 20 in the server 2 according to one embodiment. The server 2 is not limited to the HW configuration illustrated in FIGS. 3 to 5, and may be appropriately combined between the configuration examples of FIGS. 3 to 5, or may be realized with various other modifications or changes. In FIGS. 3 to 5, illustration of the HW configuration of at least a part of the server 2 illustrated in FIG. 2 is omitted.

As illustrated in FIGS. 3 to 5, an example in which the server 2 includes one or more processors 3A or 3B including a processor core 30 and a plurality of ACCs 4A or 4B is illustrated. In the following description, when the processor 3A or 3B is not distinguished, it may be simply referred to as the processor 3, and when the ACC 4A or 4B is not distinguished, it may be simply referred to as the ACC 4. The processor 3 is an example of the processor 2a illustrated in FIG. 2, and the plurality of ACCs 4 are an example of the plurality of ACCs 2b illustrated in FIG. 2.

The monitoring unit 20 (see FIGS. 3 to 5) is an example of a load distribution device that monitors a processing load of each of the plurality of ACCs 4 that execute processing of the plurality of experts 12 (see FIG. 1) and performs control to distribute the processing load of the ACCs 4. The monitoring unit 20 may be a circuit such as an integrated circuit (IC), for example, a circuit device such as an ASIC or an FPGA. The monitoring unit 20 may be communicatively connected to the processor core 30 and each of the plurality of ACCs 4.

The monitoring unit 20 may include a memory 21. The memory 21 stores information such as various data and programs including a result of monitoring by the monitoring unit 20. Examples of the memory 21 include one or both of a volatile memory and a nonvolatile memory. The monitoring unit 20 may include a processor (not illustrated) and implement a function as the monitoring unit 20 by executing a program stored in the memory 21.

The ACC 4 (see FIGS. 3 to 5) may include a memory 41. The memory 41 stores information such as various data and programs including information on the expert 12 on which the ACC 4 executes processing, for example, configuration information on the expert 12, and data (for example, input data, intermediate data, processing results, and the like) used for processing by the expert 12. Examples of the memory 41 include one or both of a volatile memory and a nonvolatile memory.

As illustrated in FIGS. 3 to 5, the plurality of ACCs 4 may be stored (accommodated) in a storage housing 40, or may be mounted in the housing of the server 2 and directly connected to the bus 2j.

The storage housing 40 is an example of a housing capable of accommodating a plurality of (two or more) ACCs 4, and accommodates a predetermined number (for example, eight) ACCs 4 in the examples of FIGS. 3 to 5. For example, the storage housing 40 may include a predetermined number (for example, eight) of slots into and from which the ACCs 4 can be inserted and removed, and the plurality of ACCs 4 may be communicably connected to the processor 3 via the slots and the IF unit 2e (see FIG. 2). In the following description, the eight ACCs 4 may be referred to as ACC#1 to ACC#8, respectively.

When the ACC 4 is compliant with the PCIe standard, the storage housing 40 may be referred to as a PCIe extended BOX. In this case, the storage housing 40 may be connected to a PCIe slot of the main body of the server 2, whereby the number of ACCs 4 that can be used as PCIe devices by the server 2 can be increased (expanded).

### First Mounting Example

In a first mounting example illustrated in FIG. 3, the monitoring unit 20 may be provided inside the processor 3A. The processor 3A includes a processor core 30 and a monitoring unit 20, and may be connected to the plurality of ACCs 4A to communicate with each other.

The processor core 30 is an arithmetic device or a control device that functions independently inside the processor 3. In the example of FIGS. 3 to 5, the processor 3 is a single-core processor including one processor core 30, but may be a multi-core processor including a plurality of processor cores 30.

### Second Mounting Example

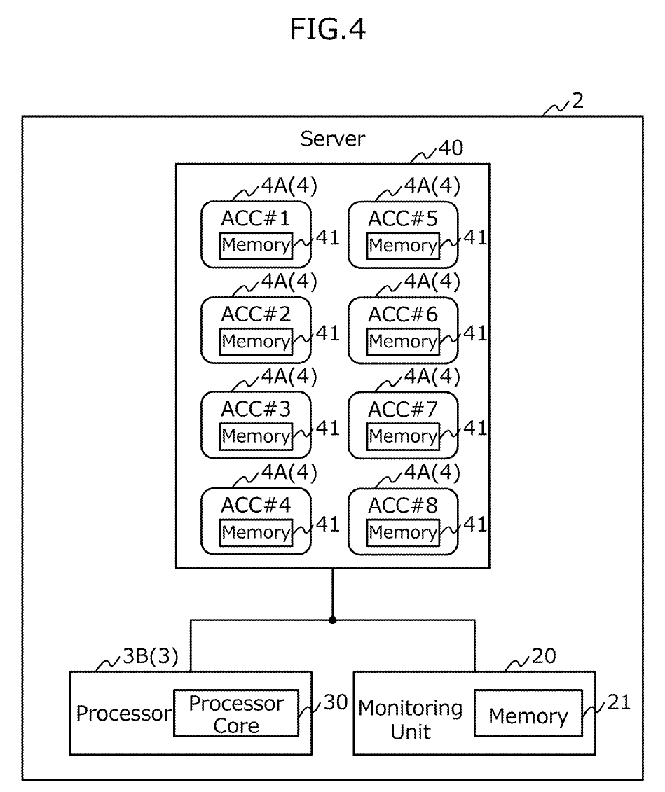

In a second mounting example illustrated in FIG. 4, unlike the first mounting example illustrated in FIG. 3, the monitoring unit 20 may be provided outside a processor 3B separately from the storage housing 40. The processor 3B is similar to the processor 3A illustrated in FIG. 3 except that the monitoring unit 20 is not provided.

The monitoring unit 20 may be connected to, for example, the bus 2j of the server 2. As an example, the monitoring unit 20 may be a device connected to the IF unit 2e of the server 2, for example, the PCIe slot.

### Third Mounting Example

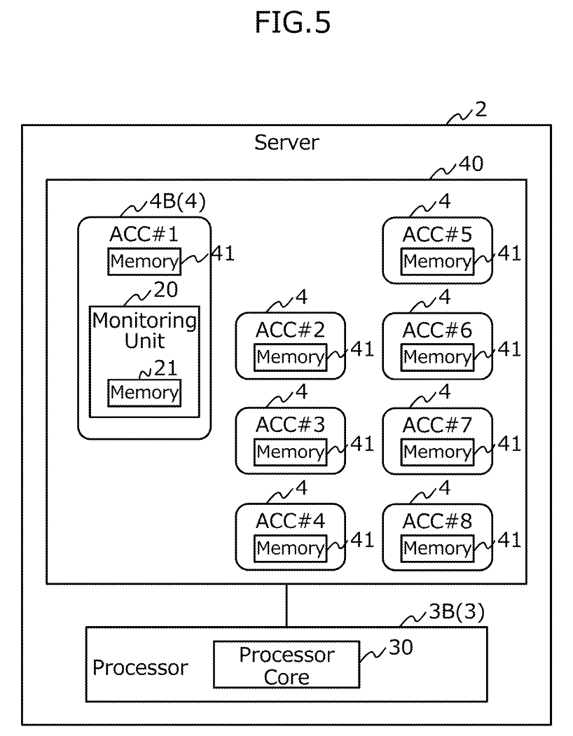

In a third mounting example illustrated in FIG. 5, the monitoring unit 20 may be provided in at least one ACC 4B among the plurality of ACCs 4. The ACC 4B is similar to the ACC 4A illustrated in FIGS. 3 and 4 except that the monitoring unit 20 is provided. FIG. 5 illustrates an example in which the monitoring unit 20 is provided in ACC#1 as the ACC 4B among ACC#1 to ACC#8, and ACC#2 to ACC#8 are the ACCs 4A, but the present embodiment is not limited thereto. The monitoring unit 20 may be provided in two or more ACCs 4B, for example, all ACC#1 to ACC#8 (ACCs 4B).

In the following description, it is assumed that the first mounting example illustrated in FIG. 3 is applied to the server 2.

### C. Functional Configuration Example

In a case where one ACC 4 executes processing of one expert 12 for the plurality of experts 12 included in the NN 1, when an imbalance of processing loads occurs among the plurality of experts 12, the processing load of the ACC 4 that executes processing of a specific expert 12 may increase. As a result, the ACC 4 becomes a bottleneck, and the processing efficiency of the entire NN 1 may decrease.

Therefore, the server 2 may perform control for reducing concentration of a processing load on a specific ACC 4 in the plurality of ACCs 4 that execute processing of the plurality of experts 12. In the following description, attention is focused on the MoE structure 10 of the NN 1.

### C-1. Functional Configuration Example of Processing Unit

FIG. 6 is a block diagram illustrating a functional configuration example of the server 2 according to one embodiment. As illustrated in FIG. 6, the server 2 may illustratively store expert information 51, allocation information 52, and gateway information 53, and may include the processing unit 5. The processing unit 5 may illustratively include an obtaining unit 54, an allocating unit 55, a process execution unit 56, and a communication unit 57.

The expert information 51, the allocation information 52, and the gateway information 53 may be stored in a storage area of one or both of the memory 2c and the storage unit 2d of the server 2 (see FIG. 2). Each of these pieces of information 51 to 53 may be data in various formats such as a table, a database (DB), and an array.

The processing unit 5 may be implemented, for example, by the processor 3 (processor core 30) of the server 2 executing the program 2h stored in the memory 2c.

The expert information 51 is an example of information on each of the plurality of experts 12. The expert information 51 may include, for example, configuration information of the NN of each of the plurality of experts 12, as an example, information regarding one or both of a structure and a parameter of the NN.

The allocation information 52 is an example of information related to allocation of the plurality of experts 12 and the plurality of ACCs 4 that execute processing of the plurality of experts 12. For example, the allocation information 52 may include information indicating a correspondence relationship of allocation between the plurality of experts 12 and the plurality of ACC#1 to ACC#8. The allocation information 52 may include information regarding past allocation of the expert 12 and the ACC 4, for example, information indicating an initial state (initial value) of the allocation, and may further include a past allocation progress (history). The allocation information 52 may include information regarding allocation of the gateway 11 and the ACC 4, for example, information indicating the ACC 4 that executes the gateway 11.

The gateway information 53 is an example of information regarding the gateway 11. The gateway information 53 may include, for example, configuration information of the NN of the gateway 11, for example, information regarding one or both of a structure and a parameter of the NN. The configuration information may include, for example, information related to a routing algorithm used by the gateway 11 to determine which expert 12 among the plurality of experts 12 is selected according to the input data. In addition, the configuration information may include, for example, information regarding the selection ratio of the ACC 4 used when one expert 12 is allocated to the plurality of ACCs 4. The information regarding the selection ratio of the ACC 4 is an example of information used for control such that each of a plurality of pieces of input data to the one expert 12 is selectively input to any one ACC 4 of the plurality of ACCs 4.

The obtaining unit 54 obtains the expert information 51, the allocation information 52, and the gateway information 53, and stores them in the storage area described above. For example, the obtaining unit 54 may obtain the information 51 to 53 generated or updated inside the server 2 or may receive the information 51 to 53 from the outside of the server 2 (for example, the user terminal or the administrator terminal).

The allocating unit 55 controls the allocation of the expert 12 to each of the plurality of ACCs 4, sets the gateway 11, and updates the allocation information 52.

For example, in response to reception of a first instruction (control signal) from the monitoring unit 20, the allocating unit 55 may set the expert 12 obtained by copying the first expert 12 allocated to the first ACC 4 to the second ACC 4. The expert 12 obtained by copying the first expert 12 may be, for example, a copy of the configuration information of the first expert 12. As a result, in response to the reception of the first instruction, the allocating unit 55 can set the expert 12 equivalent to the first expert 12 set in the first ACC 4 to the second ACC 4 at a high speed, so that it is possible to realize load distribution at an early stage.

For example, when the first expert 12 allocated to the first ACC 4 is also allocated to the second ACC 4, the allocating unit 55 may read (copy) the configuration information of the first expert 12 from the expert information 51 or the memory 41 of the first ACC 4. Then, the allocating unit 55 may set the read configuration information in the memory 41 of the second ACC 4. The first ACC 4 is an example of a first processing device, and the second ACC 4 is an example of a second processing device. The first expert 12 is an example of a first sub-model.

In addition, the allocating unit 55 may allocate (for example, set) the second expert 12 to the second ACC 4 in response to reception of a second instruction (control signal) from the monitoring unit 20. For example, the allocating unit 55 may specify the second expert 12 that has been allocated to the second ACC 4 based on the initial state (initial value) of the allocation information 52 or the past allocation history. Then, the allocating unit 55 may read (copy) the configuration information of the second expert 12 from the expert information 51 and set the read configuration information in the memory 41 of the second ACC 4. The second expert 12 is an example of a second sub-model.

The allocating unit 55 may execute initial allocation (initial setting) of the expert 12 based on the allocation information 52 to each of the plurality of ACCs 4 when the machine learning processing or the inference processing using the NN 1 by the process execution unit 56 to be described later is started.

In the setting of the gateway 11, the allocating unit 55 may obtain information regarding the gateway 11, for example, configuration information of the NN from the gateway information 53, and set (write) the obtained configuration information in the memory 41 of the ACC 4 that executes the processing of the gateway 11.

For example, the allocating unit 55 may set the gateway 11 so that each of a plurality of pieces of input data to the first expert 12 is selectively input to either the first ACC 4 or the second ACC 4 in response to the reception of the first instruction. As a result, it is possible to realize load distribution between the ACCs 4 to which the first expert 12 is allocated.

In addition, the allocating unit 55 may set the gateway 11 such that each of a plurality of pieces of input data to the first expert 12 is input to the first ACC 4 and each of a plurality of pieces of input data to the second expert 12 is input to the second ACC 4 in response to the reception of the second instruction. As a result, the second expert 12 can be made available again, and it is possible to improve the accuracy of the NN 1.

The setting of the gateway 11 by the allocating unit 55 may include, for example, processing of updating the gateway information 53, for example, information regarding one or both of the routing algorithm and the selection ratio so as to perform routing according to the first instruction or the second instruction.

In addition, in response to the reception of the first instruction or the second instruction, the allocating unit 55 may update the allocation information 52 so as to achieve the allocation (correspondence relationship) of the expert 12 and the ACC 4 according to the instruction.

The process execution unit 56 executes the machine learning processing and the inference processing using the NN 1.

For example, in a machine learning phase, the process execution unit 56 may execute the machine learning processing (training) of the MoE structure 10 using a training data set including a plurality of training data. The training data set may be prepared in advance or may be output from a preceding stage (for example, a layer) of the MoE structure 10.

As an example, the process execution unit 56 may input a token included in the training data to the ACC 4 allocated to the gateway 11. Then, the process execution unit 56 may train the gateway 11 and the plurality of experts 12 by using the processing result processed by the ACC 4 allocated to the expert 12 and output from the ACC 4 allocated to the synthesizer 13. The training may include updating of parameters of the gateway 11 and each of the plurality of experts 12, and may be realized by various known methods.

Furthermore, for example, in an inference phase, the process execution unit 56 may execute the inference processing using the MoE structure 10 using a data set including data for inference. The data set may be prepared in advance or may be output from the preceding stage (for example, a layer) of the MoE structure 10.

As an example, the process execution unit 56 may input a token included in the data for inference to the ACC 4 allocated to the gateway 11. Then, the process execution unit 56 may obtain and output the processing result processed by the ACC 4 allocated to the expert 12 and output from the ACC 4 allocated to the synthesizer 13 as the inference result of the MoE structure 10.

The inference processing may be realized by various known methods. Examples of a method of outputting the inference result include storage in a storage area of one or both of the memory 2c and the storage unit 2d of the server 2 (see FIG. 2), transmission to the outside of the server 2 (for example, the user terminal or the administrator terminal) via the IF unit 2e (see FIG. 2), or a combination thereof.

The communication unit 57 may communicate with the monitoring unit 20. For example, the communication unit 57 may transmit the allocation information 52 to the monitoring unit 20 at a predetermined timing or in response to a request. Further, for example, the communication unit 57 may receive an instruction (first instruction, second instruction) for allocating the expert 12 to the ACC 4 from the monitoring unit 20, and notify the allocating unit 55 of the instruction. Furthermore, for example, the communication unit 57 may receive monitoring information 61 from the monitoring unit 20, and may store the received monitoring information 61 in the above-described storage area of the server 2.

### C-2. Functional Configuration Example of Controller

As illustrated in FIG. 6, the monitoring unit 20 may store the monitoring information 61 and allocation information 62, and may include a controller 6. The controller 6 may illustratively include a monitor unit 63, an instruction issuing unit 64, and a communication unit 65.

The monitoring information 61 and the allocation information 62 may be stored in a storage area of the memory 21 (see FIGS. 3 to 5) of the monitoring unit 20. Each of the monitoring information 61 and the allocation information 62 may be data in various formats such as a table, a DB, and an array.

The controller 6 may be realized by, for example, a circuit logic as the monitoring unit 20 such as an ASIC or an FPGA, or may be realized by a processor (not illustrated) of the monitoring unit 20 executing a program stored in the memory 21 (see FIGS. 3 to 5).

The monitoring information 61 is an example of information on the processing load of each of the plurality of ACCs 4. Examples of an index indicating the processing load include, but are not limited to, the number of tokens with which the ACC 4 performs processing during a predetermined time (for example, one second). For example, information such as an amount of traffic between the processor core 30 and each of the plurality of ACCs 4 may be used as the index indicating the processing load.

The allocation information 62 is the allocation information 52 received by the communication unit 65 from the processing unit 5. The allocation information 62 may be updated by the monitoring unit 20 based on an instruction issued by the instruction issuing unit 64.

The monitor unit 63 performs monitoring processing of monitoring the processing load of each of the plurality of ACCs 4 that execute the processing of the plurality of experts 12 included in the NN 1 (MoE structure 10). The monitoring of the processing load may be executed, for example, at predetermined time intervals (periodically).

In one embodiment, it is assumed that one ACC 4 is allocated to each of the plurality of experts 12 in an initial state in which the machine learning processing or the inference processing using the NN 1 is executed. Meanwhile, in the monitoring processing by the monitoring unit 20, the allocation relationship between the expert 12 and the ACC 4 may change.

By monitoring the processing load for each ACC 4, the monitor unit 63 can appropriately obtain information that enables concentration (deviation), fluctuation, and the like of the processing load to be detected in units of the ACCs 4 even when the allocation relationship between the expert 12 and ACC 4 changes. The monitor unit 63 may store the monitoring result in the memory 21 as the monitoring information 61.

Hereinafter, it is assumed that the monitor unit 63 generates and updates the monitoring information 61 as the monitoring result, but the present embodiment is not limited thereto, and information on the processing load of each of the plurality of experts 12 may be generated and updated as the monitoring result.

For example, based on the monitoring information 61 and the allocation information 62, the monitor unit 63 may obtain information (correspondence information) in which the ACC 4, the expert 12 by which this ACC 4 executes processing (allocated to this ACC 4), and the processing load of this ACC 4 are associated with each other. For example, the information on the correspondence relationship can be regarded as an example of information on the processing load of each of the plurality of experts 12 by aggregating (summing) the processing load of the ACC 4 for the monitoring information 61 in units of the experts 12. In FIG. 6, the information on the correspondence relationship is denoted as load information 60.

Alternatively, the monitor unit 63 may obtain the processing load of each of the plurality of experts 12 from the processor core 30, for example, and store the processing load in the monitoring information 61. In this case, the monitor unit 63 may update, based on the allocation information 62, the monitoring information 61 as information on the processing load of each of the plurality of ACCs 4 by calculating the processing load per ACC 4 allocated to the expert 12 and adding the processing load to the monitoring information 61.

As a method of monitoring the processing load by the monitor unit 63, for example, the following method may be used according to the mounting example (see FIGS. 3 to 5) of the monitoring unit 20.

In the first mounting example (see FIG. 3), the monitor unit 63 may transmit an obtaining request of the processing load of each ACC 4 or each expert 12 to the processor core 30 at predetermined time intervals (periodically) by polling and receive a response to the obtaining request as a monitoring result. For example, the monitor unit 63 may receive, from the processor core 30, the number of tokens issued by the process execution unit 56 to each ACC 4 or each expert 12 during a predetermined time as the monitoring result, and update the monitoring information 61.

In the third mounting example (see FIG. 5), the monitor unit 63 may monitor (for example, read) the token stored in the memory 41 of each ACC 4 and obtain the monitoring result by aggregating the number of tokens stored in the memory 41 during a predetermined time. When each of the plurality of ACCs 4 includes the monitoring unit 20, the monitor unit 63 of each monitoring unit 20 may obtain the monitoring result from the memory 41 of the ACC 4 including its own monitoring unit 20. In this case, any one of the plurality of monitoring units 20 may operate as a master, and the monitor unit 63 of the master monitoring unit 20 may collect the monitoring information 61 from each monitoring unit 20 other than the master.

In the second mounting example (see FIG. 4), the monitor unit 63 may obtain the monitoring information 61 by the method described in the first or third mounting example.

The monitoring method is not limited to the above-described method, and various known methods may be used. In the first mounting example, the monitor unit 63 may monitor the token stored in the memory 41 of the ACC 4 to obtain the monitoring result, and in the third mounting example, the monitor unit 63 may perform polling on the processor core 30 to obtain the monitoring result.

The instruction issuing unit 64 performs control (first control, second control) for changing the allocation between the expert 12 and the ACC 4 based on the monitoring information 61 and the allocation information 62.

For example, when the instruction issuing unit 64 detects the first ACC 4 with the processing load equal to or more than a first threshold, the instruction issuing unit 64 executes the first control for allocating the first expert 12 to the second ACC 4, based on the allocation information 62, the second ACC 4 being different from the first ACC 4 to which the first expert 12 is allocated and having the processing load less than the first threshold. The second ACC 4 is the ACC 4 to which the second expert 12 different from the first expert 12 is allocated.

The first threshold is a threshold for detecting the first ACC 4 on which the processing load is concentrated, and may be set in the monitoring unit 20 by, for example, the user terminal or the administrator terminal, or may be set by the processor 3 based on the monitoring result of the performance of the NN 1, the processing performance of the ACC 4, or the like.

For example, the instruction issuing unit 64 may compare the processing load of each of the plurality of ACCs 4 with the first threshold based on the monitoring information 61, and may determine to execute the load distribution of the first ACC 4, in other words, to execute the first control, when detecting the first ACC 4 in which the processing load is equal to or more than the first threshold.

When determining to execute the load distribution, the instruction issuing unit 64 may specify any one of one or more ACCs 4 in which the processing load is equal to or less than a given threshold among the plurality of ACCs 4, for example, the second ACC 4 having the minimum processing load based on the monitoring information 61. The second expert 12 allocated to the second ACC 4 can also be said to be the expert 12 having a relatively small processing load among the plurality of experts 12, which is the smallest as an example. The given threshold may be, for example, less than the first threshold.

Then, the instruction issuing unit 64 may generate an instruction (first instruction, control signal) for allocating (copying) the first expert 12 allocated to the first ACC 4 on which the processing load is concentrated to the second ACC 4, and issue the instruction to the processor core 30. The first instruction may include information indicating the specified first ACC 4 and information indicating the specified second ACC 4. In addition, the first instruction is an example of an instruction for performing control so that each of the plurality of pieces of input data to the first expert 12 is selectively input to either the first ACC 4 or the second ACC 4.

When the allocating unit 55 changes the allocation of the expert 12 and the ACC 4 in response to the first instruction, the processing of the first expert 12 is executed in a distributed manner to the first ACC 4 and the second ACC 4. As a result, it is possible to reduce the processing load per ACC 4 allocated to the first expert 12.

The second expert 12 whose allocation from the second ACC 4 is released by the first control is not executed in the NN 1 (MoE structure 10) (is not selected by the gateway 11). The monitor unit 63 selects, as the second ACC 4, the ACC 4 having the processing load equal to or less than the given threshold (for example, minimum), so that the performance degradation of the NN 1 due to the allocation of the first expert 12 instead of the second expert 12 can be minimized.

As described above, according to the instruction issuing unit 64, when the first ACC 4 with the processing load equal to or more than the first threshold is detected, the control for allocating the first expert 12 to the second ACC 4 is executed. As a result, it is possible to reduce the concentration of the processing load on a specific ACC 4 (first ACC 4). In addition, it is possible to prevent the first ACC 4 from becoming a bottleneck and eventually, it is possible to suppress a decrease in the processing efficiency of the entire NN 1, to realize optimization of the performance of the NN 1, and to stably execute the NN 1.

Here, there is a possibility that the tendency of the gateway 11 to select the expert 12 changes depending on various factors such as the content of the training data or the inference data input to the NN 1 (MoE structure 10), the progress of the machine learning processing, and the like. Therefore, after the allocation is changed by the first control, the processing load of the first expert 12 (the sum of the processing loads of the first ACC 4 and the second ACC 4) may fall below the first threshold, and the load distribution of the first expert 12 may become unnecessary.

Therefore, when determining that the processing load of the first expert 12 after the execution of the first control (after the issuance of the first instruction) is equal to or less than a second threshold, the instruction issuing unit 64 may execute the second control for allocating the second expert 12 to the second ACC 4.

The second threshold is a threshold for detecting that the concentration of the processing load on the first expert 12 is resolved, and may be, for example, less than the first threshold. The second threshold may be set in the monitoring unit 20 by, for example, the user terminal or the administrator terminal, or may be set by the processor 3 based on a monitoring result of performance of the NN 1, processing performance of the ACC 4, or the like.

For example, the instruction issuing unit 64 may calculate, as the processing load of the first expert 12 after the execution of the first control, a total processing load of the processing load of the first expert 12 allocated to the first ACC 4 and the processing load of the first expert 12 allocated to the second ACC 4. Then, the instruction issuing unit 64 may compare the processing load of the first expert 12 with the second threshold, and when the processing load of the first expert 12 is determined to be equal to or less than the second threshold for a certain period of time, may determine to return to the allocation before the execution of the first control, in other words, to execute the second control. The certain period of time is a period for preventing erroneous determination that the overload of the first expert 12 has been resolved due to a temporary change in the processing load.

When the instruction issuing unit 64 determines to return to the allocation before the execution of the first control, the instruction issuing unit 64 may generate an instruction (second instruction, control signal) for allocating the second expert 12 to the second ACC 4 and issue the instruction to the processor core 30. The second instruction may include information indicating the second ACC 4. The second instruction is an example of an instruction for performing control such that each of a plurality of pieces of input data to the first expert 12 is input to the first ACC 4 and each of a plurality of pieces of input data to the second expert 12 is input to the second ACC 4.

When the allocation of the expert 12 and the ACC 4 is changed by the allocating unit 55 in response to the second instruction, in the second ACC 4, the processing of the second expert 12 previously allocated to the second ACC 4 is executed instead of the processing of the first expert 12.

As described above, according to the instruction issuing unit 64, when the processing load of the first expert 12 is determined to be equal to or less than the second threshold, control for allocating the second expert 12 to the second ACC 4 is executed. As a result, when the load distribution of the first expert 12 becomes unnecessary, it is possible to return to the state before the load distribution, so that the second expert 12 can be used again, and it is possible to improve the accuracy of the NN 1.

The communication unit 65 may communicate with the processing unit 5. For example, the communication unit 65 may transmit a transmission request of the allocation information 52 to the communication unit 57, may receive the allocation information 52 from the communication unit 57, and may store the received allocation information 52 in the memory 21 (see FIG. 3) as the allocation information 62. Further, for example, the communication unit 65 may transmit the instruction (first instruction, second instruction) from the instruction issuing unit 64 to the communication unit 57. Furthermore, for example, the communication unit 65 may transmit the monitoring information 61 to the communication unit 57 at a predetermined timing.

### C-3. Description of Load Distribution Processing by Processing Unit and Controller

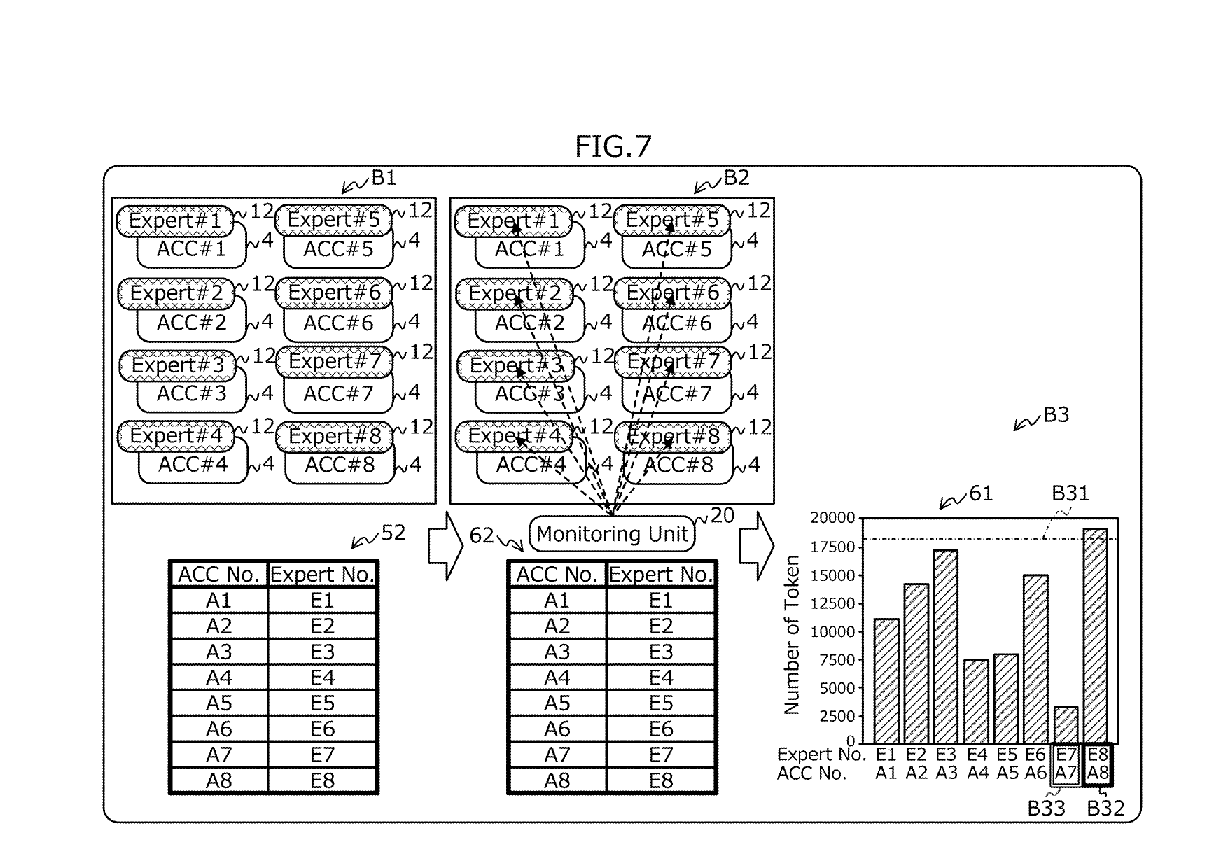

FIGS. 7 to 9 are diagrams illustrating an example of the load distribution processing of the ACC 4 according to one embodiment. In the description of FIGS. 7 to 9, the plurality of ACC#1 to ACC#8 are referred to as ACC#1 to ACC#8 or A1 to A8, and the plurality of expert#1 to expert#8 are referred to as Expert#1 to Expert#8 or E1 to E8.

The upper part of the sheet of a reference numeral B1 in FIG. 7 illustrates a state (initial state) in which expert#1 to expert#8 are allocated to ACC#1 to ACC#8, respectively, by the allocating unit 55 of the processing unit 5 is illustrated in the upper part of the sheet of the reference numeral B1 in FIG. 7. The state in which the expert 12 is allocated to the ACC 4 may mean a state in which the expert information 51, for example, configuration information is set in the memory 41 (not illustrated) of the ACC 4.

The lower part of the sheet of the reference numeral B1 illustrates an example of the allocation information 52 of the processing unit 5 in this state. The allocation information 52 may include an ACC number (referred to as “ACC No.”) and an expert number (referred to as “Expert No.”). The ACC number is an example of identification information of the ACC 4, and the expert number is an example of identification information of the expert 12.

The upper part of the sheet of a reference numeral B2 illustrates a state in which the monitor unit 63 of the monitoring unit 20 monitors the processing loads of the expert#1 to expert#8 during execution of the machine learning processing or the inference processing using the NN 1 by the process execution unit 56. The gateway 11 selects any one ACC 4 among ACC#1 to ACC#8 according to the input data (token) input to the NN 1 (MoE structure 10), and outputs the input data to the selected ACC 4. The ACC 4 to which the input data is input executes processing of the expert 12 according to the configuration information stored in the memory 41 using this input data, and outputs processing result data to the synthesizer 13. As a result, output data is output from the MoE structure 10.

The lower part of the sheet of the reference numeral B2 illustrates an example of the allocation information 62 updated by the allocation information 52 obtained from the processing unit 5 by the monitoring unit 20.

A reference numeral B3 is a graph indicating the number of tokens arranged (distributed) in each of the expert#1 to expert#8 at a predetermined time. A vertical axis of the graph B3 indicates the number of tokens, and a horizontal axis indicates the expert number and the ACC number. The graph B3 is an example of the monitoring information 61.

The graph B3 illustrates a case where the processing load is concentrated on one expert#8 and the processing load of ACC#8 is high. The instruction issuing unit 64 determines that the processing load of ACC#8 is equal to or more than the first threshold B31 based on the monitoring information 61 (see a thick line frame B32). The expert#8 is an example of the first expert 12, and ACC#8 is an example of the first ACC 4.

In addition, the instruction issuing unit 64 specifies the ACC 4 to be a new (additional) allocation destination of the expert#8 based on the monitoring information 61. The graph B3 illustrates a case where the instruction issuing unit 64 specifies ACC#7 to which the expert #7 having the processing load equal to or less than the given threshold, for example, the lowest processing load, is allocated, as the allocation destination (see a double line frame B33). The expert#7 is an example of the second expert 12, and ACC#7 is an example of the second ACC 4.

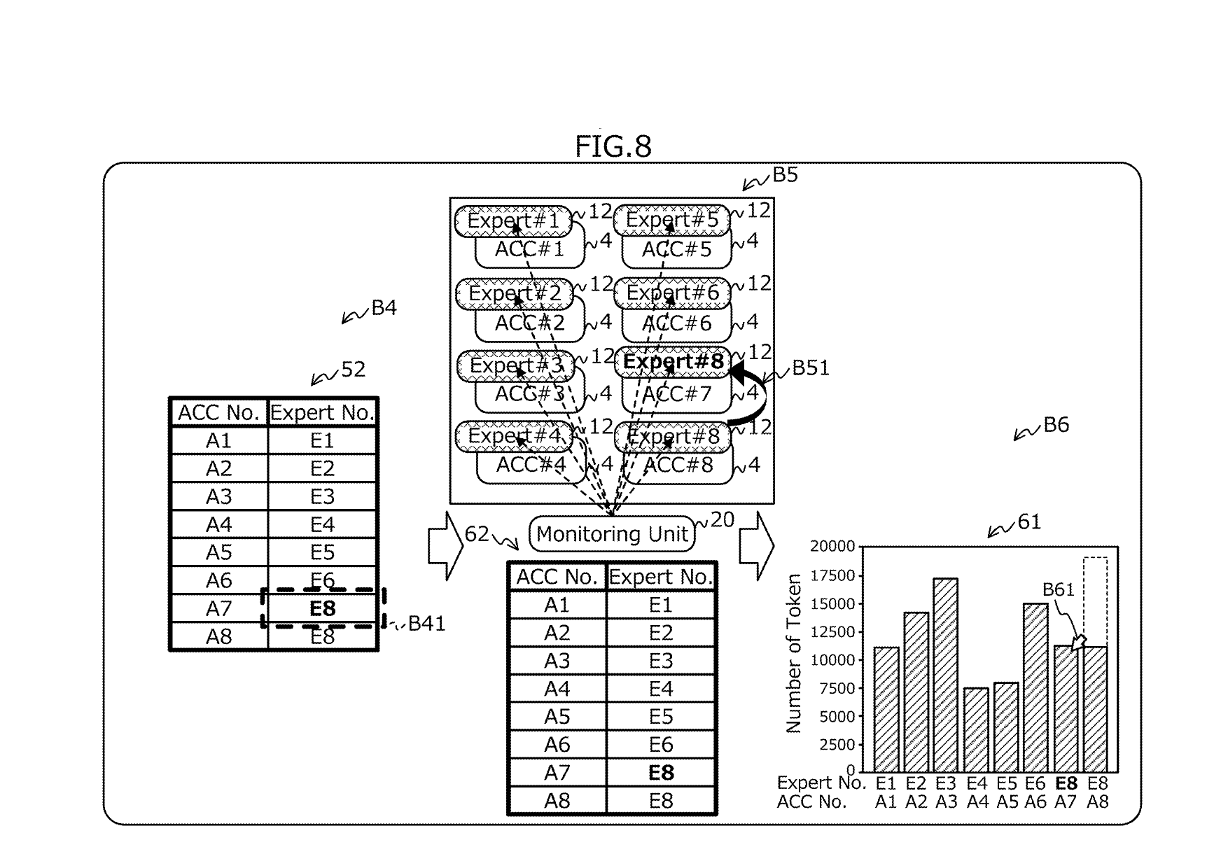

A reference numeral B4 and the lower part of the sheet of a reference numeral B5 in FIG. 8 illustrate an example of the allocation information 52 and 62 after the issuance of the first instruction by the instruction issuing unit 64. The instruction issuing unit 64 issues an instruction (first instruction) for allocating the expert#8 to ACC#7 to the processing unit 5. In response to this instruction, the allocating unit 55 of the processing unit 5 updates the allocation information 52 so as to indicate that the expert#8 is allocated to ACC#7 (see a thick broken line frame B41).

The upper part of the sheet of the reference numeral B5 illustrates an example in which the allocating unit 55 allocates the expert#8 to ACC#7 by copying the expert#8 and setting the expert#8 to ACC#7 based on the instruction from the instruction issuing unit 64. As an example, the allocating unit 55 may copy the configuration information of the expert#8 stored in the memory 41 (not illustrated) of ACC#8 or the expert information 51, and write this configuration information in the memory 41 of ACC#7 (see a reference numeral B51).

In addition, the allocating unit 55 may update the gateway information 53 in accordance with the change of the allocation information 52. For example, the allocating unit 55 may update the routing algorithm such that the output destination (distribution destination) of each of the plurality of pieces of input data from the gateway 11 is one of the expert#1 to expert#6 and expert#8 different from the expert#7. Further, the allocating unit 55 may update information regarding the selection ratio of ACC 4 included in the gateway information 53. For example, the allocating unit 55 may update the information regarding the selection ratio so that each of the plurality of pieces of input data to the expert#8 is selectively input to either ACC#7 orACC#8.

A reference numeral B6 is a graph indicating the number of tokens arranged (distributed) in each of the expert#1 to expert#6 and expert#8 in a predetermined time. The graph B6 illustrates a state in which the processing load of ACC#8 is reduced by distributing the processing load of the expert#8 to ACC#7 and ACC#8 (see arrow B61). As a result, since the processing of the expert#8 is executed in ACC#7 or ACC#8 according to the predetermined selection ratio set in the gateway 11, it is possible to reduce the imbalance of the processing load among the plurality of ACCs 4, for example, to alleviate the concentration of the processing load on the specific ACC#8.

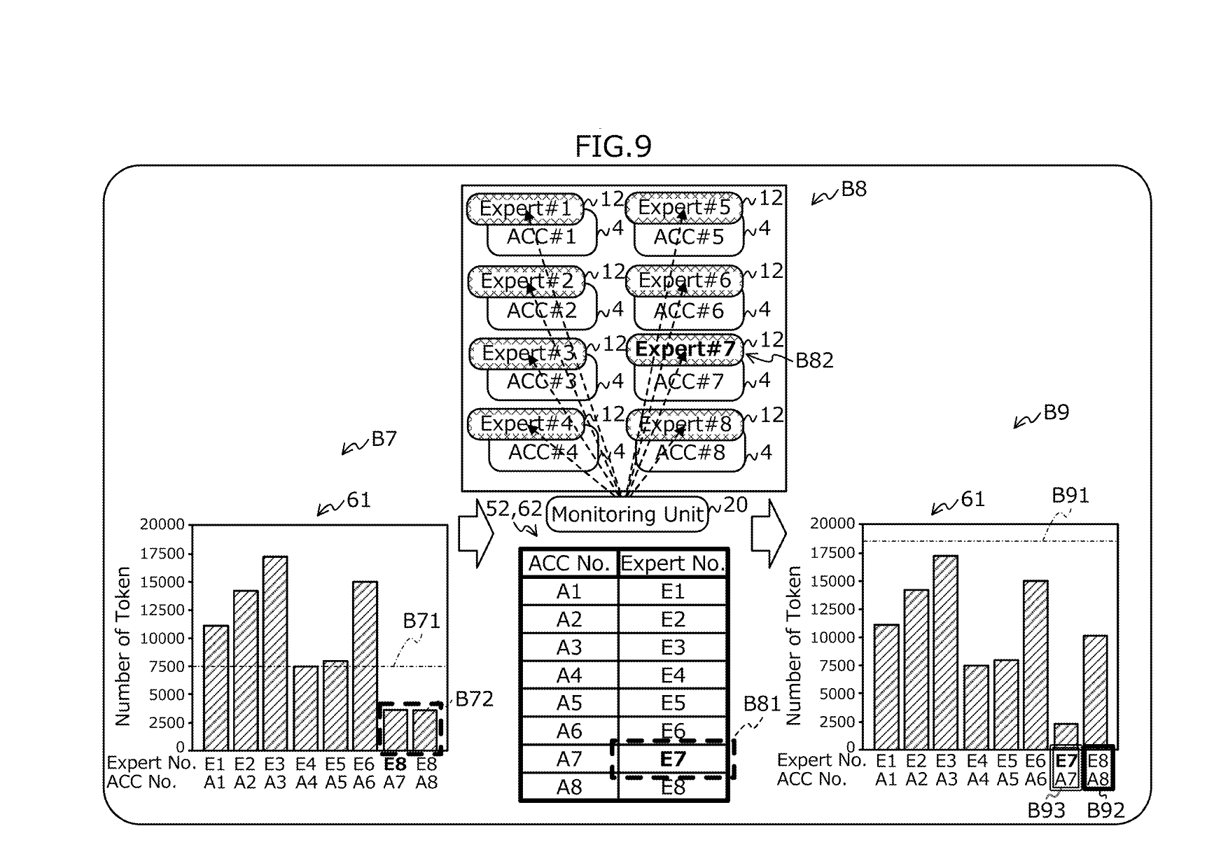

A reference numeral B7 in FIG. 9 is a graph illustrating the number of tokens arranged (distributed) to each of the expert#1 to expert#6 and expert#8 in a predetermined time in a state where the concentration of the processing load on the expert#8 is settled after the execution of the load distribution. The instruction issuing unit 64 determines that the processing load of the expert#8 allocated to ACC#7 and ACC#8 is equal to or less than the second threshold B71 which is less than the first threshold B31 based on the monitoring information 61 obtained by monitoring continuously executed by the monitor unit 63 (see a thick broken line frame B72). The processing load of the expert#8 allocated to ACC#7 and ACC#8 may be the sum (for example, the total number of tokens) of the processing load of ACC#7 and the processing load of ACC#8.

The lower part of the sheet of a reference numeral B8 illustrates an example of the allocation information 52 and 62 after the issuance of the second instruction by the instruction issuing unit 64. The instruction issuing unit 64 issues an instruction (second instruction) for allocating the expert#7 to ACC#7 to the processing unit 5. In response to this second instruction, the allocating unit 55 of the processing unit 5 updates the allocation information 52 so as to indicate that the expert#7 is allocated to ACC#7. Along with the update of the allocation information 52, the monitoring unit 20 obtains the allocation information 52 from the processing unit 5 and updates the allocation information 62 (see a thick broken line frame B81).

The upper part of the sheet of the reference numeral B8 illustrates an example in which the allocating unit 55 allocates (returns to an original state) the expert#7 to ACC#7 by setting the expert#7 to ACC#7 based on the instruction from the instruction issuing unit 6. As an example, the allocating unit 55 may copy the configuration information of the expert#7 stored in the expert information 51 based on the initial state of the allocation or the past allocation history included in the allocation information 52, and write this configuration information in the memory 41 (not illustrated) of ACC#7 (see a reference numeral B82). As a result, it is possible to return the allocation of the expert 12 and the ACC 4 to the allocation before the distribution processing is executed.

In addition, the allocating unit 55 may update the gateway information 53 in accordance with the change of the allocation information 52. For example, the allocating unit 55 may update the routing algorithm such that the output destination (distribution destination) of each of the plurality of pieces of input data from the gateway 11 is any one of the expert#1 to expert#8 including the expert#7. Further, the allocating unit 55 may update information regarding the selection ratio of the ACC 4 included in the gateway information 53. For example, the allocating unit 55 may update the information on the selection ratio such that each of a plurality of pieces of input data to the expert#8 is input to ACC#8 and each of a plurality of pieces of input data to the expert#7 is input to ACC#7. As a result, the expert#7 becomes available similarly to before the execution of the distribution processing, and thus, it is possible to suppress a decrease in accuracy of the NN 1.

A reference numeral B9 is a graph indicating the number of tokens arranged (distributed) to each of the expert#1 to expert#8 in a predetermined time in a state after the allocation of the expert 12 and the ACC 4 is returned to the original state. The graph B9 illustrates a state in which the concentration of the processing load on the expert#8 is settled, and the processing loads of the expert#8 (see a thick line frame B92) and the expert#7 (see a double line frame B93) are both less than the first threshold B91. The monitor unit 63 may continue monitoring the processing load of the expert 12. The instruction issuing unit 64 may execute the above-described load distribution processing when the processing load of any of the experts 12 is determined to be equal to or more than the first threshold based on the monitoring information 61.

### D. Operation Example

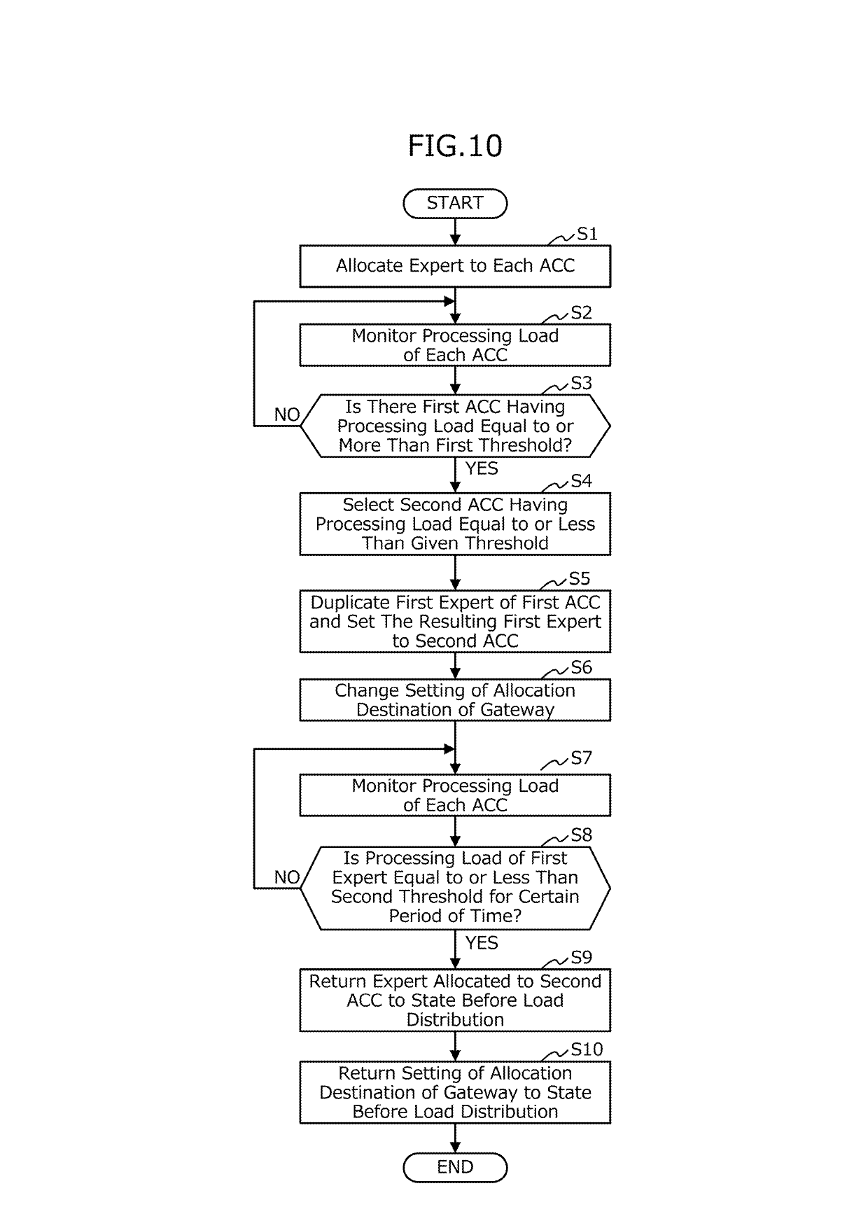

Next, an operation example of the server 2 according to one embodiment will be described. FIG. 10 is a flowchart illustrating the operation example of the server 2 according to one embodiment. Hereinafter, an example of the above-described processing by the server 2 will be described with reference to the flowchart.

As illustrated in FIG. 10, the allocating unit 55 of the processing unit 5 allocates the expert 12 to each ACC 4 based on the allocation information 52 (Step S1). Thereafter, the process execution unit 56 executes the machine learning processing or the inference processing using the NN 1 including the MoE structure 10. The subsequent processing may be performed during execution of the machine learning processing or the inference processing.

The monitor unit 63 of the monitoring unit 20 monitors the processing load of each of the plurality of ACCs 4 (Step S2) and stores the monitoring result in the monitoring information 61. The monitoring and updating of the monitoring information 61 may be executed, for example, at predetermined time intervals.

Based on the monitoring information 61, the instruction issuing unit 64 determines whether there is the first ACC 4 with the processing load equal to or more than the first threshold (Step S3). When there is no first ACC 4 (NO in Step S3), the processing returns to Step S2.

When there is the first ACC 4 (YES in Step S3), the instruction issuing unit 64 selects the second ACC 4 having the processing load equal to or less than the given threshold (for example, the lowest) among the plurality of ACCs 4 based on the monitoring information 61 (Step S4). The instruction issuing unit 64 issues (transmits) the first instruction (instruction) for changing the allocation of the second ACC 4 to the processing unit 5.

In accordance with the first instruction, the allocating unit 55 changes the expert 12 allocated to the second ACC 4 in the allocation information 52 from the second expert 12 to the first expert 12 allocated to the first ACC 4. The allocating unit 55 copies the first expert 12 allocated to the first ACC 4, and sets the copied first expert 12 to the second ACC 4 (Step S5).

In addition, the allocating unit 55 updates the information regarding the routing algorithm and the selection ratio of the gateway information 53 according to the first instruction, thereby changing the setting of the distribution destination of the gateway 11 (Step S6).

The monitor unit 63 continues to monitor the processing load of each of the plurality of ACCs 4 (Step S7) and stores the monitoring result in the monitoring information 61.

The instruction issuing unit 64 determines whether the processing load of the first expert 12 (the sum of the processing loads of the first ACC 4 and the second ACC 4) is equal to or less than the second threshold for a certain period of time based on the monitoring information 61 (Step S8). When the processing load of the first expert 12 is more than the second threshold or when the period during which the processing load is equal to or less than the second threshold is less than the certain period of time (NO in Step S8), the processing returns to Step S7.

When the processing load of the first expert 12 is equal to or less than the second threshold for the certain period of time (YES in Step S8), the instruction issuing unit 64 issues (transmits) the second instruction to the processing unit 5. The second instruction may be an instruction for returning the expert 12 to be allocated to the second ACC 4 to the state before the load distribution in Steps S4 to S6 is performed.

In accordance with the second instruction, the allocating unit 55 changes the expert 12 allocated to the second ACC 4 in the allocation information 52 from the first expert 12 to the second expert 12 before the load distribution is performed. The allocating unit 55 sets the configuration information of the second expert 12 included in the expert information 51 to the second ACC 4 (Step S9).

In addition, in accordance with the second instruction, the allocating unit 55 returns the setting of the distribution destination of the gateway 11 by returning the information regarding the routing algorithm and the selection ratio of the gateway information 53 to the state before the change of the setting in Step S6 (Step S10), and the processing ends.

### E. Others

The technology according to the above-described embodiment can be modified and changed as follows.

For example, in FIG. 6, the functional blocks 54 to 57 included in the server 2 and the functional blocks 63 to 65 included in the monitoring unit 20 may be merged in an arbitrary combination or may be divided. In addition, the information 51 to 53 stored in the server 2 and the information 61 and 62 (60) stored in the monitoring unit 20 may be merged in an arbitrary combination or may be divided.

In one embodiment, the case where the NN 1 is the LLM has been described as an example, but the NN 1 may be a machine learning model other than the LLM, for example, a deep NN (DNN). In addition, the description has been given assuming that the input data to the MoE structure 10 is a token, but the present embodiment is not limited thereto. The input data to the MoE structure 10 may be, for example, various character strings such as words, phrases, and sentences, or may be input data corresponding to data input to the NN 1 in a case where the NN 1 is a machine learning model other than LLM.

In one embodiment, the instruction issuing unit 64 specifies one second ACC 4 as an example, but the present embodiment is not limited thereto, and two or more second ACCs 4 may be specified.

In one aspect, according to the present embodiment, it is possible to reduce concentration of a processing load on a specific processing device in a plurality of processing devices that execute processing of a plurality of sub-models.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A load distribution device comprising:
a memory; and
a controller coupled to the memory, the controller being configured to execute a control process comprising:
monitoring a processing load of each of a plurality of processing devices configured to execute processing of a plurality of sub-models included in a machine learning model, and
executing, when a first processing device having a processing load equal to or more than a first threshold is detected, first control for allocating a first sub-model to a second processing device to which a second sub-model different from the first sub-model is allocated, based on allocation of the plurality of sub-models and the plurality of processing devices, the second processing device being different from the first processing device to which the first sub-model is allocated and having the processing load less than the first threshold.

2. The load distribution device according to claim 1,
wherein the first control comprises controlling for setting, in the second processing device, a sub-model obtained by copying the first sub-model allocated to the first processing device.

3. The load distribution device according to claim 1,
wherein the first control comprises controlling for setting a gateway connected to a preceding stage of the plurality of sub-models such that each of a plurality of pieces of input data to the first sub-model is selectively input to any one of the first processing device and the second processing device.

4. The load distribution device according to claim 1,
wherein the control process comprises executing second control for allocating the second sub-model to the second processing device when, by the monitoring, a processing load of the first sub-model after execution of the first control is determined to be equal to or less than a second threshold less than the first threshold.

5. The load distribution device according to claim 4,
wherein the second control comprises controlling for setting a gateway connected to a preceding stage of the plurality of sub-models such that each of a plurality of pieces of input data to the first sub-model is input to the first processing device and each of a plurality of pieces of input data to the second sub-model is input to the second processing device.

6. A load distribution method, executed by a load distribution device, the load distribution method comprising:
monitoring a processing load of each of a plurality of processing devices configured to execute processing of a plurality of sub-models included in a machine learning model; and
executing, when a first processing device having a processing load equal to or more than a first threshold is detected, first control for allocating a first sub-model to a second processing device to which a second sub-model different from the first sub-model is allocated, based on allocation of the plurality of sub-models and the plurality of processing devices, the second processing device being different from the first processing device to which the first sub-model is allocated and having the processing load less than the first threshold.

7. The load distribution method according to claim 6,
wherein the first control comprises controlling for setting, in the second processing device, a sub-model obtained by copying the first sub-model allocated to the first processing device.

8. The load distribution method according to claim 6,
wherein the first control comprises controlling for setting a gateway connected to a preceding stage of the plurality of sub-models such that each of a plurality of pieces of input data to the first sub-model is selectively input to any one of the first processing device and the second processing device.

9. The load distribution method according to claim 6, further comprising
executing second control for allocating the second sub-model to the second processing device when, by the monitoring, a processing load of the first sub-model after execution of the first control is determined to be equal to or less than a second threshold less than the first threshold.

10. The load distribution method according to claim 9,
wherein the second control comprises controlling for setting a gateway connected to a preceding stage of the plurality of sub-models such that each of a plurality of pieces of input data to the first sub-model is input to the first processing device and each of a plurality of pieces of input data to the second sub-model is input to the second processing device.

11. An information processing apparatus comprising:
a load distribution device configured to perform load distribution in a plurality of processing devices configured to execute processing of a plurality of sub-models included in a machine learning model; and
a processor configured to control allocation between the plurality of sub-models and the plurality of processing devices,
wherein the load distribution device is configured to execute a control process comprising:
monitoring a processing load of each of a plurality of processing devices configured to execute processing of a plurality of sub-models included in a machine learning model, and
executing, when a first processing device having a processing load equal to or more than a first threshold is detected, first control for allocating a first sub-model to a second processing device to which a second sub-model different from the first sub-model is allocated, based on allocation of the plurality of sub-models and the plurality of processing devices, the second processing device being different from the first processing device to which the first sub-model is allocated and having the processing load less than the first threshold.

12. The information processing apparatus according to claim 11,
wherein the first control comprises controlling for setting, in the second processing device, a sub-model obtained by copying the first sub-model allocated to the first processing device.

13. The information processing apparatus according to claim 11,
wherein the first control comprises controlling for setting a gateway connected to a preceding stage of the plurality of sub-models such that each of a plurality of pieces of input data to the first sub-model is selectively input to any one of the first processing device and the second processing device.

14. The information processing apparatus according to claim 11,
wherein the control process comprises executing second control for allocating the second sub-model to the second processing device when, by the monitoring, a processing load of the first sub-model after execution of the first control is determined to be equal to or less than a second threshold less than the first threshold.

15. The information processing apparatus according to claim 14,
wherein the second control comprises controlling for setting a gateway connected to a preceding stage of the plurality of sub-models such that each of a plurality of pieces of input data to the first sub-model is input to the first processing device and each of a plurality of pieces of input data to the second sub-model is input to the second processing device.
